(19) United States
(12) Patent Application Publication
(10) Pub. No.: US 2022/0012665 A1
(43) Pub. Date: Jan. 13, 2022

(54) WORK INSTRUCTION DEVICE, WORK INSTRUCTION SYSTEM, AND WORK INSTRUCTION METHOD

(71) Applicant: Hitachi, Ltd., Tokyo (JP)

(72) Inventors: Yuuichi SUGINISHI, Tokyo (JP); Masafumi OKADA, Tokyo (JP); Natsuhiko INAKI, Tokyo (JP)

(21) Appl. No.: 17/363,164

(22) Filed: Jun. 30, 2021

(30) Foreign Application Priority Data
Jul. 7, 2020 (JP) 2020-116954

(51) Int. Cl. G06Q 10/06

(52) U.S. Cl. CPC G06Q 10/06375

(57) ABSTRACT

A production loss is reduced using shop-floor data. A work instruction device includes: a storage unit configured to store shop-floor data including production performance information for each manufactured object manufactured at a manufacturing shop-floor, worker dynamics information obtained from a sensor attached to a worker at the manufacturing shop-floor, and information on an operation history of a facility at the manufacturing shop-floor; a production loss occurrence pattern extraction unit configured to analyze the shop-floor data based on a predetermined method to generate a production loss occurrence pattern; and a work instruction generation unit configured to estimate occurrence of a production loss based on a work plan for a work corresponding to a date and time, a facility, and a worker corresponding to the production loss occurrence pattern to generate work instruction information including information on a cause of the production loss.

### CROSS-REFERENCE TO RELATED APPLICATION

The present application claims priority from Japanese application JP 2020-116954, filed on Jul. 7, 2020, the contents of which is hereby incorporated by reference into this application.

### TECHNICAL FIELD

The present invention relates to a work instruction device, a work instruction system, and a work instruction method.

### BACKGROUND ART

PTL 1 describes that structure information of a similar work model having a size different from that of a base work model and having a shape similar to that of the base work model is acquired, and work path information of the base work model is used to create similar welding line information for creating work path information of the similar work model based on the acquired structure information of the similar workpiece model.

### CITATION LIST

### Patent Literature

PTL 1: JP-A-2014-194658

### SUMMARY OF INVENTION

### Technical Problem

According to a technique described in the above-mentioned PTL 1, a recommended countermeasure can be generated each time, but prediction and versatility are insufficient since a versatile pattern cannot be generated inductively.

An object of the invention is to reduce a production loss using shop-floor data (4M data: Man, Machine, Material, and Method).

### Solution to Problem

The present application includes a plurality of units that solves at least a part of the above-described problems. An example of the units is as follows. In order to solve the above-described problems, a work instruction device according to an aspect of the invention includes: a storage unit configured to store shop-floor data including production performance information for each manufactured object manufactured at a manufacturing shop-floor, worker dynamics information obtained from a sensor attached to a worker at the manufacturing shop-floor, and information on an operation history of a facility at the manufacturing shop-floor; a production loss occurrence pattern extraction unit configured to analyze the shop-floor data based on a predetermined method to generate a production loss occurrence pattern; and a work instruction generation unit configured to estimate occurrence of a production loss based on a work plan for a work corresponding to a date and time, a facility, and a worker corresponding to the production loss occurrence pattern to generate work instruction information including information on a cause of the production loss.

### Advantageous Effect

According to the invention, a production loss can be reduced using shop-floor data (4M data). Accordingly, it is possible to achieve a manufacturing shop-floor having high productivity, such as an improvement in an operation rate of a manufacturing device, an increase in a production amount, a reduction in manufacturing lead time, and compliance of a delivery time. Problems, configurations, and effects other than those described above will be clarified by the following description in embodiments.

### BRIEF DESCRIPTION OF DRAWINGS

FIG. 1 is a diagram showing a configuration example of a work instruction system according to a first embodiment of the invention.

FIG. 2 is a diagram showing a configuration example of a work instruction device.

FIG. 3 is a diagram showing an example of a data structure of a production performance storage unit.

FIG. 4 is a diagram showing an example of a data structure of a worker dynamics storage unit.

FIG. 5 is a diagram showing an example of a data structure of a facility operation history storage unit.

FIG. 6 is a diagram showing an example of a data structure of a work procedure storage unit.

FIG. 7 is a diagram showing an example of a data structure of a production loss occurrence pattern storage unit.

FIG. 8 is a diagram showing an example of a data structure of a work instruction storage unit.

FIG. 9 is a diagram showing an example of a hardware configuration of the work instruction device.

FIG. 10 is a diagram showing an example of a flow of production loss occurrence pattern extraction processing for each facility.

FIG. 11 is a diagram showing an example of a flow of production loss extraction processing.

FIG. 12 is a diagram showing an example of the production loss extraction processing.

FIG. 13 is a diagram showing an example of a flow of work instruction display processing for each worker.

FIG. 14 is a diagram showing an example of a work instruction screen for worker.

FIG. 15 is a diagram showing an example of a flow of work instruction display processing for each facility.

FIG. 16 is a diagram showing an example of a work instruction screen for facility.

FIG. 17 is a diagram showing an example of a loss occurrence reference setting screen.

### DESCRIPTION OF EMBODIMENTS

Hereinafter, an embodiment of the invention will be described with reference to the drawings. The same components are denoted by the same reference symbols in principle throughout all the drawings showing the embodiment, and the repetitive description thereof is omitted. In the embodiments described below, it is needless to say that the components (including element steps and the like) are not always indispensable unless otherwise stated or except a case in which the components are apparently indispensable in principle. It is needless to say that expressions “formed of A”, “made of A”, “having A”, and “including A” do not exclude elements other than A unless otherwise stated that A is the only element. Similarly, in the embodiments described below, when a shape and positional relation of the components and the like are mentioned, substantially approximate and similar shapes and the like are included therein unless otherwise stated or except a case in which it can be conceived that the substantially approximate and similar shapes and the like are apparently excluded in principle.

In a factory in a company that runs a manufacturing industry, for a product to be produced, a future production plan is often drafted based on a production facility used in each production process and time invested in each production facility, so that daily production activities are often performed in accordance with the production plan. In such a manufacturing shop-floor, due to various factors such as workers, facilities, and manufactured objects themselves, various large and small delays with respect to the plan occur.

In particular, in an environment in which many types of products are to be produced and a product type mixing ratio changes from moment to moment, since manufacturing processes vary widely and are complicated depending on the product type, it tends to be difficult to predict events that are likely to occur in advance.

In order to know the events that are likely to occur at an early stage, it is necessary to accurately acquire and utilize a production progress status. However, in a case in which the variation of the product type is rapid, it is conceivable to statistically analyze events occurring in the past to specify a day of the week, a time zone, an area, a work order, and the like in which a production loss is likely to occur as a pattern, and to predict the production loss in accordance with the worker, the production facility, the product, and the like.

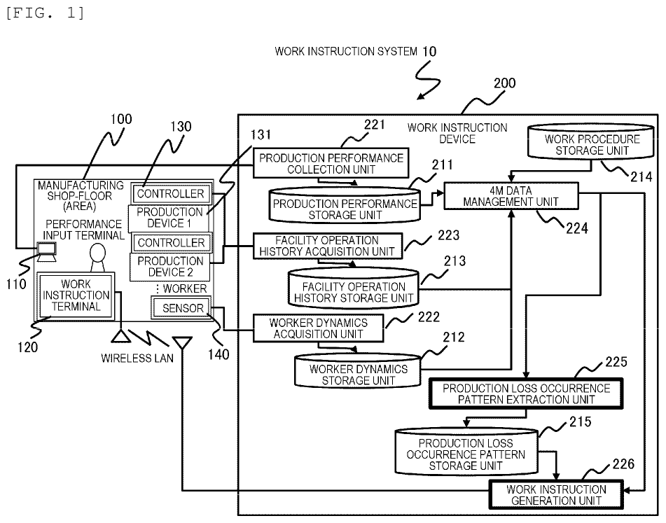

FIG. 1 is a diagram showing a configuration example of a work instruction system according to a first embodiment of the invention. A work instruction system 10 includes a production shop-floor device group that is provided in a manufacturing shop-floor (area) 100, and a work instruction device 200 that is communicably connected to the production shop-floor device group via a network.

The network is, for example, any one of a communication network using a part or all of a general public line such as a local area network (LAN), a wide area network (WAN), a virtual private network (VPN), or the Internet, a mobile phone communication network, and the like, or a combined network thereof. The network may be a wireless communication network such as Wi-Fi (registered trademark) or 5G (Generation).

The production shop-floor device group includes a performance input terminal 110, a work instruction terminal 120, a controller 130, a production device 131, and other devices such as a sensor 140 that acquires operations of various tools and the worker and the like. The performance input terminal 110 is a production performance collection device that receives, by an operator, an input of performance information such as an identifier of an individual to be manufactured and a start time point and an end time point of a process. The work instruction terminal 120 is a terminal that is operated by the operator, displays screen information generated by the work instruction device 200, receives an operation input on a screen thereof, and requests the work instruction device 200 to perform processing or the like.

The controller 130 is a device that controls an operation of the production device 131. The controller 130 monitors information such as time points of an operation start, an operation state, a non-operation state, an operation end, and the like of the production device 131, and transmits the information to a facility operation history acquisition unit 223 of the work instruction device 200 via the network. The production device 131 is a device that is used for production, for example, a device such as a numerical control processing device (NC device). An example is given in which the operation information of the production device 131 is transmitted to the work instruction device by the controller 130. However, the invention is not limited thereto, and the operation information of the production device 131 may be transmitted to the work instruction device 200 by the production device 131 itself.

The sensor 140 includes a device that acquires operation information of a worker who operates the production device 131, for example, an acceleration sensor, a camera, a heart rate sensor, or a temperature sensor. The sensor 140 monitors the information such as time points of an operation start, an operation state, a non-operation state, an operation end, and the like of the worker, and transmits the information to a worker dynamics acquisition unit 222 of the work instruction device 200 via the network.

The work instruction device 200 executes various types of processing such as production loss occurrence pattern extraction processing, production loss extraction processing, work instruction display processing for each worker, and work instruction display processing for each facility using shop-floor data (4M data: Man, Machine, Material, and Method) including worker dynamics information, facility operation history information, production performance information, and work procedure, which are acquired from the production shop-floor device group.

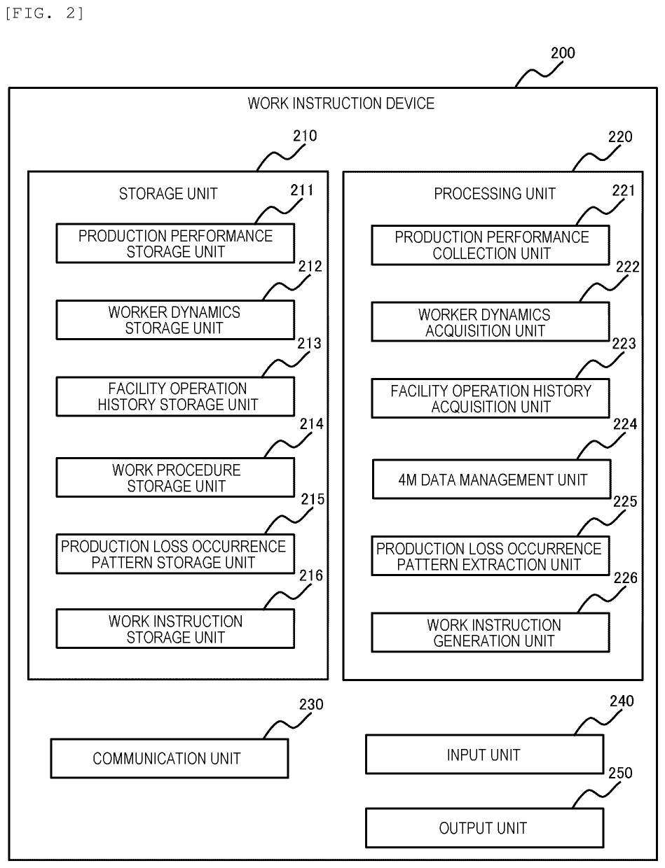

FIG. 2 is a diagram showing a configuration example of a work instruction device. A work instruction device 200 includes a storage unit 210, a processing unit 220, a communication unit 230, an input unit 240, and an output unit 250.

The storage unit 210 includes a production performance storage unit 211, a worker dynamics storage unit 212, a facility operation history storage unit 213, a work procedure storage unit 214, a production loss occurrence pattern storage unit 215, and a work instruction storage unit 216.

The production performance storage unit 211 stores, for each manufactured object such as parts or a product, information for specifying a work (processing) of the process, a time point at which a work (processing) of a previous process is completed, a time point at which the work (processing) is started, a time point at which the work (processing) is completed, a production facility that performs the work (processing), and a worker who performs the work (processing).

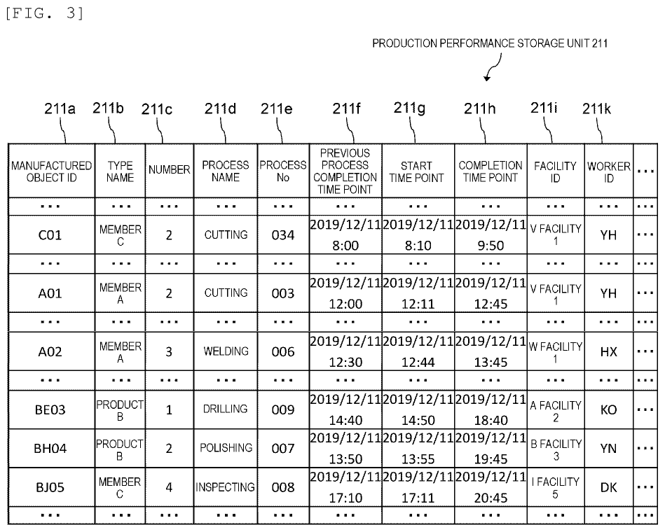

FIG. 3 is a diagram showing an example of a data structure of a production performance storage unit. The production performance storage unit 211 stores information acquired from the performance input terminal 110 by a production performance collection unit 221 described later.

The production performance storage unit 211 includes a manufactured object ID column 211a, a type name column 211b, a number column 211c, a process name column 211d, a process No column 211e, a previous process completion time point column 211f, a start time point column 211g, a completion time point column 211h, a facility ID column 211i, and a worker ID column 211k.

The manufactured object ID column 211a, the type name column 211b, the number column 211c, the process name column 211d, the process No column 211e, the previous process completion time point column 211f, the start time point column 211g, the completion time point column 211h, the facility ID column 211i, and the worker ID column 211k are associated with one another.

The manufactured object ID column 211a stores information that specifies manufactured object IDs, which are identification information capable of uniquely identifying each manufactured object such as a product or parts.

The type name column 211b stores information for specifying types of the manufactured objects specified in the manufactured object ID column 211a.

The number column 211c stores information for specifying quantities of manufactured objects included in the manufactured objects specified in the manufactured object ID column 211a.

The process name column 211d stores information for specifying process names for identifying processes of processing the manufactured objects specified in the manufactured object ID column 211a.

The process No column 211e stores information for specifying the number, counting from a first process, of the processes in the process name column 211d for the manufactured objects specified in the manufactured object ID column 211a.

The previous process completion time point column 211f stores information for specifying time points, at which previous processes of the processes specified in the process name column 211d are completed, for the manufactured objects specified in the manufactured object ID column 211a.

The start time point column 211g stores information for specifying time points, at which processing in the processes specified in the process name column 211d is started, for the manufactured objects specified in the manufactured object ID column 211a.

The completion time point column 211h stores information for specifying time points, at which the processing in the processes specified in the process name column 211d is completed, for the manufactured objects specified in the manufactured object ID column 211a.

The facility ID column 211i stores information for specifying facility IDs used in the processing in the processes specified in the process name column 211d for the manufactured objects specified in the manufactured object ID column 211a in periods from the start time points specified in the start time point column 211g to the end time points specified in the completion time point column 211h.

The worker ID column 211k stores information for specifying worker IDs in charge of the processing in the processes specified in the process name column 211d for the manufactured objects specified in the manufactured object ID column 211a in the periods from the start time points specified in the start time point column 211g to the end time points specified in the completion time point column 211h.

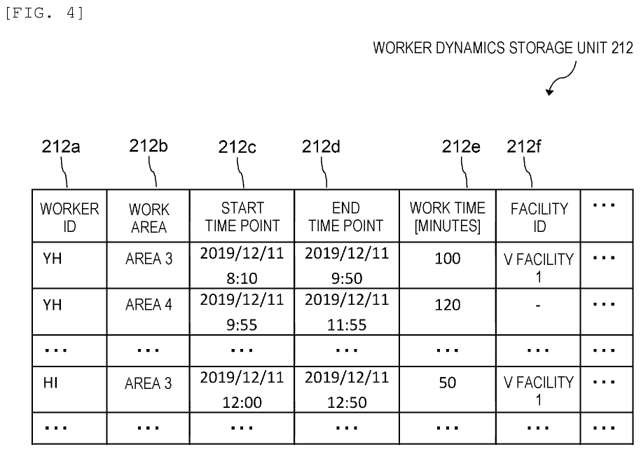

FIG. 4 is a diagram showing an example of a data structure of a worker dynamics storage unit. The worker dynamics storage unit 212 stores information that is acquired from the sensor 140 by the worker dynamics acquisition unit 222 described later.

The worker dynamics storage unit 212 includes a worker ID column 212a, a work area column 212b, a start time point column 212c, an end time point column 212d, a work time column 212e, and a facility ID column 212f.

The worker ID column 212a, the work area column 212b, the start time point column 212c, the end time point column 212d, the work time column 212e, and the facility ID column 212f are associated with one another.

The worker ID column 212a stores identification information capable of specifying the workers.

The work area column 212b stores information for specifying positions (work areas) of the workers specified in the worker ID column 212a in a factory.

The start time point column 212c stores information for specifying time points at which the workers specified in the worker ID column 212a start works in the work areas specified in the work area column 212b.

The end time point column 212d stores information for specifying time points at which the workers specified in the worker ID column 212a end the works in the work areas specified in the work area column 212b.

The work time column 212e stores information for specifying work times of the workers specified in the worker ID column 212a in periods from the time points at which the workers specified in the worker ID column 212a start works in the work areas specified in the work area column 212b to the time points at which the workers specified in the worker ID column 212a end the works in the work areas specified in the work area column 212b.

The facility ID column 212f stores information for specifying facilities used when the workers specified in the worker ID column 212a perform the works in the work areas specified in the work area column 212b.

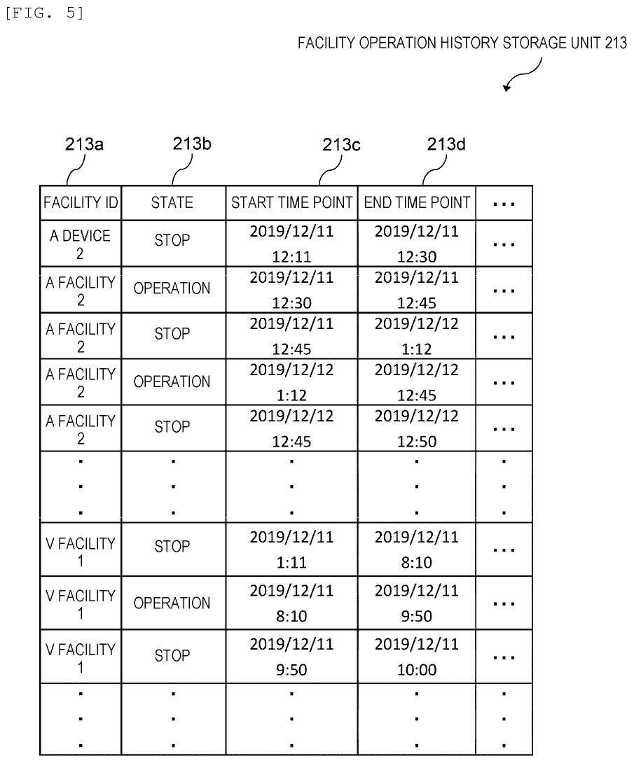

FIG. 5 is a diagram showing an example of a data structure of a facility operation history storage unit. The facility operation history storage unit 213 stores information that is acquired from the controller 130 or the production device 131 by the facility operation history acquisition unit 223 described later.

The facility operation history storage unit 213 includes a facility ID column 213a, a state column 213b, a start time point column 213c, and an end time point column 213d.

The facility ID column 213a, the state column 213b, the start time point column 213c, and the end time point column 213d are associated with one another.

The facility ID column 213a stores identification information capable of specifying the controller 130 or the production device 131 of the production facility.

The state column 213b stores information for specifying operation states of the facilities specified in the facility ID column 213a.

The start time point column 213c stores information for specifying time points at which the facilities specified in the facility ID column 213a are in the states specified in the state column 213b.

The end time point column 213d stores information for specifying time points at which the facilities specified in the facility ID column 213a exit the states specified in the state column 213b.

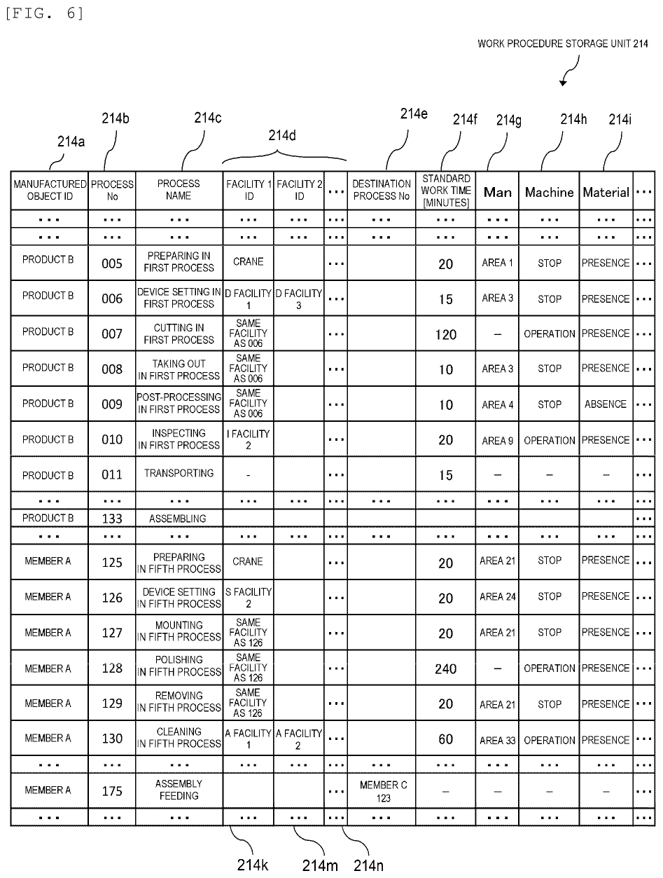

FIG. 6 is a diagram showing an example of a data structure of a work procedure storage unit. A work procedure storage unit 214 stores a predetermined work procedure.

The work procedure storage unit 214 includes a manufactured object ID column 214a, a process No column 214b, a process name column 214c, a usage facility column 214d, a destination process No column 214e, a standard work time column 214f, a Man column 214g, a Machine column 214h, and a Material column 214i. Since the usage facility column 214d may include a plurality of facilities, when the facilities are distinguished, the facilities are described regarding a facility 1ID column 214k, a facility 2ID column 214m, and a facility 31D column 214n.

The manufactured object ID column 214a, the process No column 214b, the process name column 214c, the usage facility column 214d, the destination process No column 214e, the standard work time column 214f, the Man column 214g, the Machine column 214h, and the Material column 214i are associated with one another.

The manufactured object ID column 214a stores information for specifying manufactured object IDs, which are identification information capable of uniquely identifying each manufactured object such as a product or parts.

The process No column 214b stores numbers for specifying the processes. The number is information for specifying an execution order.

The process name column 214c stores names of processes specified in the process No column 214b. The usage facility column 214d stores information for specifying facilities used in the processes specified in the process No column 214b.

The destination process No column 214e stores numbers for specifying a process to be sent next to the processes specified in the process No column 214b.

The standard work time column 214f stores information for specifying work times that are standards of the processes specified in the process No column 214b.

The Man column 214g stores information for specifying Man elements, for example, areas where the workers work, among the 4M data constituting the shop-floor data.

The Machine column 214h stores information for specifying Machine elements, for example, operation states of facilities used for the works, among the 4M data constituting the shop-floor data.

The Material column 214i stores information for specifying Material elements, for example, the presence or absence of materials used for the works, among the 4M data constituting the shop-floor data. The standard work time column 214f, the Man column 214g, the Machine column 214h, and the Material column 214i may be collectively referred to as work model data.

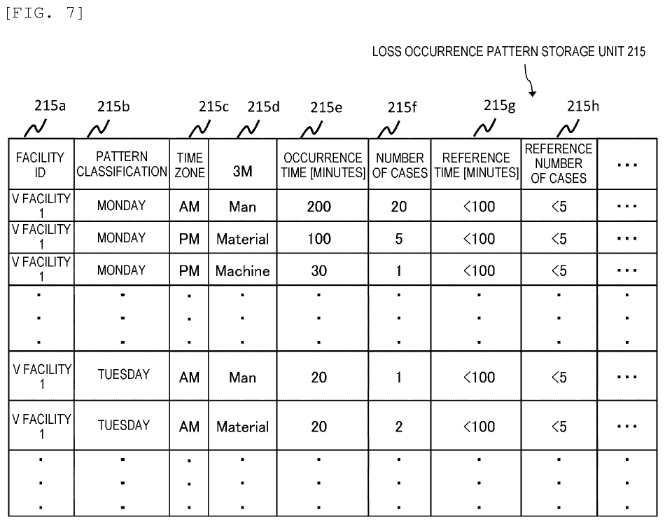

FIG. 7 is a diagram showing an example of a data structure of a production loss occurrence pattern storage unit. The production loss occurrence pattern storage unit 215 stores a pattern in which a production loss occurs, for example, a production loss occurrence pattern including information for specifying conditions when 3M non-operation occurs more than a predetermined frequency or 3M non-operation occurs more than a predetermined time.

The production loss occurrence pattern storage unit 215 includes a facility ID column 215a, a pattern classification column 215b, a time zone column 215c, a 3M column 215d, an occurrence time column 215e, a number of cases column 215f, a reference time column 215g, and a reference number of cases column 215h.

The facility ID column 215a stores information for specifying production facilities in which the production loss occurs. The pattern classification column 215b, the time zone column 215c, the 3M column 215d, the occurrence time column 215e, and the number of cases column 215f store information for specifying days of the week in which the production loss occurs, predetermined time zones in which the production loss occurs, Man, Machine, and Material (3M) elements related to the production loss, stop times showing scales of the production loss, and the number of cases showing frequencies of the production loss, respectively.

The reference time column 215g stores references of the stop time for determining whether there is a production loss. The reference number of cases column 215h stores references of the number of occurrences for determining whether the production loss frequently occurs.

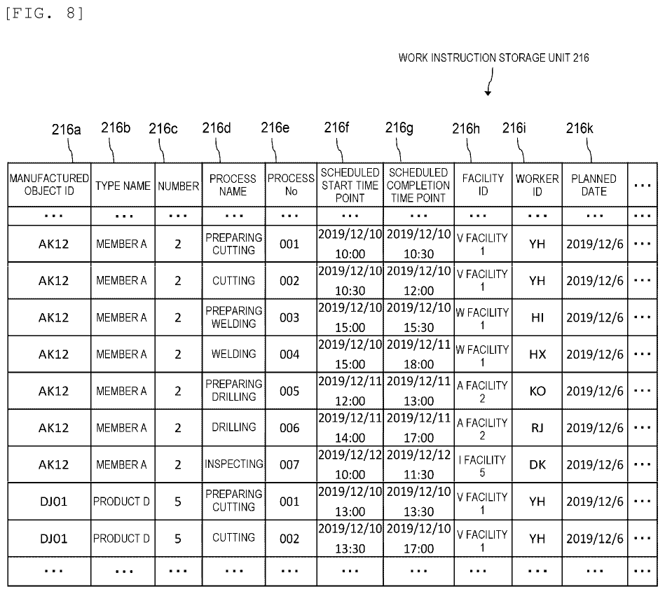

FIG. 8 is a diagram showing an example of a data structure of a work instruction storage unit. The work instruction storage unit 216 includes a manufactured object ID column 216a, a type name column 216b, a number column 216c, a process name column 216d, a process No column 216e, a scheduled start time point column 216f, a scheduled completion time point column 216g, a facility ID column 216h, a worker ID column 216i, and a planned date column 216k.

The manufactured object ID column 216a, the type name column 216b, the number column 216c, the process name column 216d, the process No column 216e, the scheduled start time point column 216f, the scheduled completion time point column 216g, the facility ID column 216h, the worker ID column 216i, and the planned date column 216k are associated with one another.

The manufactured object ID column 216a stores information for specifying manufactured object IDs, which are identification information capable of uniquely identifying each manufactured object such as a product or parts.

The type name column 216b stores information for specifying types of the manufactured objects specified in the manufactured object ID column 216a.

The number column 216c stores information for specifying quantities of manufactured objects included in the manufactured objects specified in the manufactured object ID column 216a.

The process name column 216d stores information for specifying process names for identifying processes of processing the manufactured objects specified in the manufactured object ID column 216a.

The process No column 216e stores information for specifying the number, counting from a first process, of the processes in the process name column 216d for the manufactured objects specified in the manufactured object ID column 216a.

The scheduled start time point column 216f stores information for specifying scheduled time points, at which the processing in the processes specified in the process name column 216d is started, for the manufactured objects specified in the manufactured object ID column 216a.

The scheduled completion time point column 216g stores information for specifying scheduled time points, at which the processing in the processes specified in the process name column 216d is completed, for the manufactured objects specified in the manufactured object ID column 216a.

The facility ID column 216h stores information for specifying facility IDs used in the processing in the processes specified in the process name column 216d for the manufactured objects specified in the manufactured object ID column 216a in periods from the scheduled start time points specified in the scheduled start time point column 216f to the scheduled end time points specified in the scheduled completion time point column 216g.

The worker ID column 216i stores information for specifying worker IDs in charge of the processing in the processes specified in the process name column 216d for the manufactured objects specified in the manufactured object ID column 216a in the periods from the scheduled start time points specified in the scheduled start time point column 216f to scheduled completion time points specified in the scheduled completion time point column 216g.

The planned date column 216k stores information for specifying a date on which a work instruction is created.

The description will return to FIG. 2. The processing unit 220 of the work instruction device 200 includes the production performance collection unit 221, the worker dynamics acquisition unit 222, the facility operation history acquisition unit 223, a 4M data management unit 224, a production loss occurrence pattern extraction unit 225, and a work instruction generation unit 226.

The production performance collection unit 221 acquires and updates the information stored in the production performance storage unit 211 from the performance input terminal 110 at a predetermined time (for example, every day) or at a designated time. More specifically, the production performance collection unit 221 collects performances of start and end time points of a manufacturing process transmitted from a production shop-floor device via the communication unit 230.

The worker dynamics acquisition unit 222 acquires and updates the information stored in the worker dynamics storage unit 212 from the sensor 140 at a predetermined cycle (for example, every five seconds) or a designated cycle. More specifically, the worker dynamics acquisition unit 222 collects a position of a worker and a performance of a work that are transmitted from the production shop-floor device via the communication unit 230.

The facility operation history acquisition unit 223 acquires and updates the information stored in the facility operation history storage unit 213 from the controller 130 and the production device 131 at a predetermined cycle (for example, every five seconds) or at a designated cycle. More specifically, the facility operation history acquisition unit 223 collects an operation performance of a facility transmitted from the production shop-floor device via the communication unit 230.

The 4M data management unit 224 manages the 4M data (production performance (Material), a facility operation (Machine), the worker (Man), and the work procedure (Method)). Specifically, the 4M data management unit 224 performs various analyses and learning using the production performance storage unit 211, the worker dynamics storage unit 212, the facility operation history storage unit 213, and the work procedure storage unit 214, and provides an analysis result when a request for necessary information is received.

The production loss occurrence pattern extraction unit 225 analyzes the shop-floor data based on a predetermined method to generate an occurrence pattern of the production loss. Specifically, the production loss occurrence pattern extraction unit 225 extracts the occurrence pattern of the production loss using the analysis result obtained from the 4M data management unit 224, and stores the extracted occurrence pattern in the production loss occurrence pattern storage unit 215.

The work instruction generation unit 226 estimates the occurrence of the production loss from a work plan for a work corresponding to a date and time, a facility, and a worker corresponding to the production loss occurrence pattern to generate work instruction information including information on a cause of the production loss. The work instruction generation unit 226 transmits the work instruction information to the work instruction terminal 120 via the network such as a wireless local area network (LAN) and displays the work instruction information.

The communication unit 230 transmits and receives information to and from other devices via the network.

The input unit 240 receives input information input using a keyboard or a mouse, for example, by being displayed and operated on a screen.

The output unit 250 outputs, for example, screen information including information to be output as a result of performing predetermined processing to the work instruction terminal 120 via the communication unit 230.

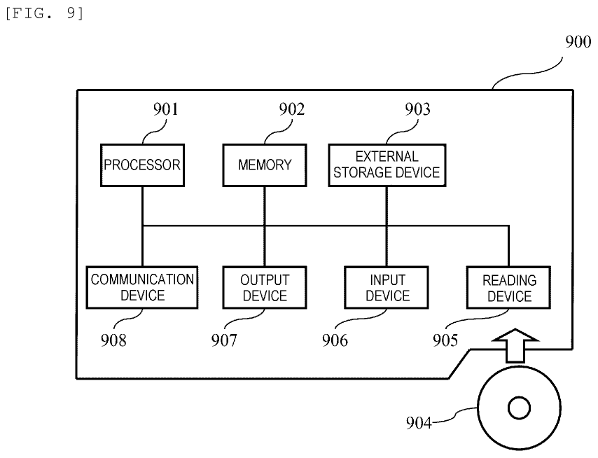

FIG. 9 is a diagram showing an example of a hardware configuration of the work instruction device. The work instruction device 200 can be implemented by a general computer 900 including a processor (for example, a central processing unit (CPU)) 901, a memory 902, an external storage device 903 such as a hard disk drive (HDD) and a solid state drive (SSD), a reading device 905 that reads information from a portable storage medium 904 such as a compact disk (CD) and a digital versatile disk (DVD), an input device 906 such as a keyboard, a mouse, a barcode reader, and a touch panel, an output device 907 such as a display, and a communication device 908 that communicates with another computer via a communication network such as a LAN or the Internet. Alternatively, the work instruction device 200 can be implemented by a network system including a plurality of the computers 900. It is needless to say that the reading device 905 may be capable of executing writing as well as executing reading from the portable storage medium 904.

For example, the production performance collection unit 221, the worker dynamics acquisition unit 222, the facility operation history acquisition unit 223, the 4M data management unit 224, the production loss occurrence pattern extraction unit 225, and the work instruction generation unit 226 that are provided in the processing unit 220 can be implemented by loading a predetermined program stored in the external storage device 903 in the memory 902 and executing the program by the processor 901. The input unit 240 can be implemented by the processor 901 using the input device 906. The output unit 250 can be implemented by the processor 901 using the output device 907. The communication unit 230 can be implemented by the processor 901 using the communication device 908. The storage unit 210 can be implemented by the processor 901 using the memory 902 or the external storage device 903.

The predetermined program may be downloaded into the external storage device 903 from the portable storage medium 904 via the reading device 905 or from the network via the communication device 908, and then may be loaded into the memory 902 and executed by the processor 901. The predetermined program may be directly loaded into the memory 902 from the portable storage medium 904 via the reading device 905 or from the network via the communication device 908, and may be executed by the processor 901.

The performance input terminal 110 and the work instruction terminal 120 can also be implemented by the general computer 900 as shown in FIG. 9.

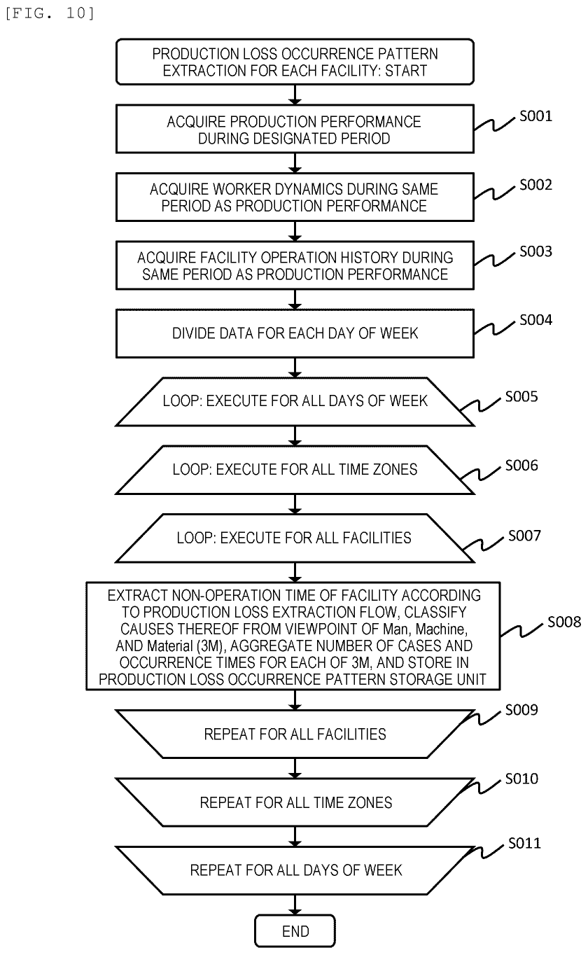

FIG. 10 is a diagram showing an example of a flow of production loss occurrence pattern extraction processing for each facility. The production loss occurrence pattern extraction processing for each facility is started at a predetermined time (for example, every day) or when an instruction to start the processing is issued to the work instruction device 200.

First, the production performance collection unit 221 acquires production performance during a designated period (step S001). Specifically, the production performance collection unit 221 acquires the production performance during the designated period from the performance input terminal 110, and stores the production performance during the designated period in the production performance storage unit 211.

Then, the worker dynamics acquisition unit 222 acquires worker dynamics during the same period as the production performance (step S002). Specifically, the worker dynamics acquisition unit 222 acquires, from the sensor 140, the worker dynamics during the same period as a period in which the production performance is acquired in step S001, and stores the worker dynamics in the worker dynamics storage unit 212.

Then, the facility operation history acquisition unit 223 acquires a facility operation history during the same period as the production performance (step S003). Specifically, the facility operation history acquisition unit 223 acquires, from the controller 130 and the production device 131, a facility operation history during the same period as the period in which the production performance is acquired in step S001, and stores the facility operation history in the facility operation history storage unit 213.

Then, the 4M data management unit 224 divides the data for each day of the week (step S004). Specifically, the 4M data management unit 224 divides the information (3M data) acquired and stored in steps S001 to S003 for each day of the week, paying attention to a time related to the data. For example, if the 4M data management unit 224 is the production performance storage unit 211, the 4M data management unit 224 divides records according to the day of the week related to a date and time of the production. Similarly, if the 4M data management unit 224 is the worker dynamics storage unit 212, the 4M data management unit 224 divides the records according to the day of the week related to a date and time of the operation of the worker. If the 4M data management unit 224 is the facility operation history storage unit 213, the 4M data management unit 224 divides the records according to the day of the week related to a date and time when the facility is operated or stopped.

Then, the production loss occurrence pattern extraction unit 225 performs steps S006 to S010 described later for each day of the week (steps S005 and S011).

The production loss occurrence pattern extraction unit 225 performs step S007 to step S009 described later for each predetermined time zone (for example, a time zone in a time unit) (steps S006 and S010).

The production loss occurrence pattern extraction unit 225 performs step S008 described later for each facility (for example, numerical control machine tool) (steps S007 and S009).

The production loss occurrence pattern extraction unit 225 extracts a non-operation time of the facility according to a production loss extraction flow, classifies causes of the production loss from the viewpoint of Man, Machine, and Material (3M), aggregates the number of cases and occurrence times for each element, and stores the non-operation time of the facility, the causes of the production loss, and the number of cases and the occurrence times in the production loss occurrence pattern storage unit 215 (step S008).

The above is an example of the flow of the production loss occurrence pattern extraction processing for each facility. According to the production loss occurrence pattern extraction processing for each facility, the production loss occurrence pattern can be specified by being classified according to the non-operating time of the facility and the cause of the production loss.

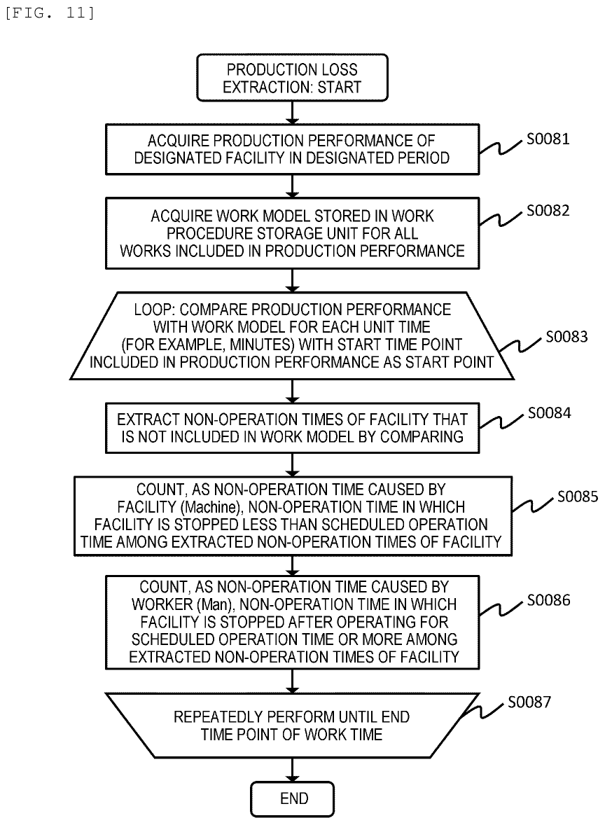

FIG. 11 is a diagram showing an example of a flow of production loss extraction processing. The production loss extraction processing is performed in step S008 of the production loss occurrence pattern extraction processing for each facility.

First, the production loss occurrence pattern extraction unit 225 acquires a production performance of a designated facility in the designated period (step S0081).

Then, the production loss occurrence pattern extraction unit 225 acquires a work model stored in the work procedure storage unit 214 for all works included in the production performance (step S0082).

Then, the production loss occurrence pattern extraction unit 225 performs processing in step S0084 to step S0086 of determining the factor of the cause by comparing the production performance with the work model for each unit time (for example, minutes) with the start time point included in the production performance as a start point (steps S0083 and S0087).

The production loss occurrence pattern extraction unit 225 compares the production performance with the work model to extract the non-operation times of the facility that is not included in the work model (step S0084).

Then, the production loss occurrence pattern extraction unit 225 counts, as a non-operation time caused by the facility (Machine), a non-operation time in which the facility is stopped less than a scheduled operation time among the extracted non-operation times of the facility (step S0085).

Then, the production loss occurrence pattern extraction unit 225 counts, as a non-operation time caused by the worker (Man), a non-operation time in which the facility is stopped after operating for the scheduled operation time or more among the extracted non-operation times of the facility (step S0086).

The above is an example of the flow of the production loss extraction processing. According to the production loss extraction processing, the non-operation time of the facility can be extracted and the cause of the production loss can be classified from the viewpoint of Man, Machine, and Material (3M).

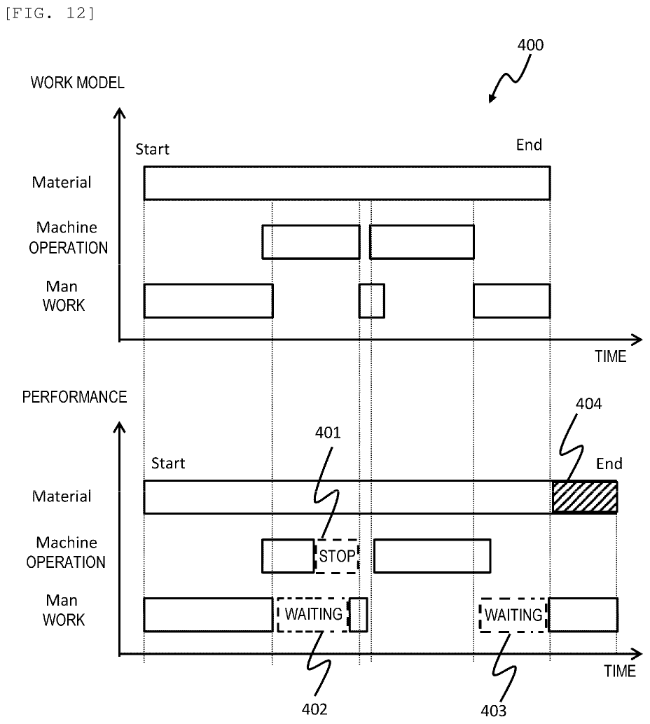

FIG. 12 is a diagram showing an example of production loss extraction processing. A model in which an irregular production loss does not occur is referred to as a work model 400. In the work model 400, it is defined whether the elements of 3M which are Material, Machine, and Man are in the operation state or in the non-operation state along a time axis. On the other hand, also regarding the production performance, the operation state and the non-operation state are plotted on the same time axis, and the difference between the elements of each of 3M is extracted. Depending on whether the element is in the non-operation state without reaching the operation time or is operated and stopped beyond the operation time, a Machine non-operation time 401 that is caused by Machine, Man non-operation times 402 and 403 that are caused by Machine, and a delay of Material that is caused by Man, that is, a production loss 404, are extracted.

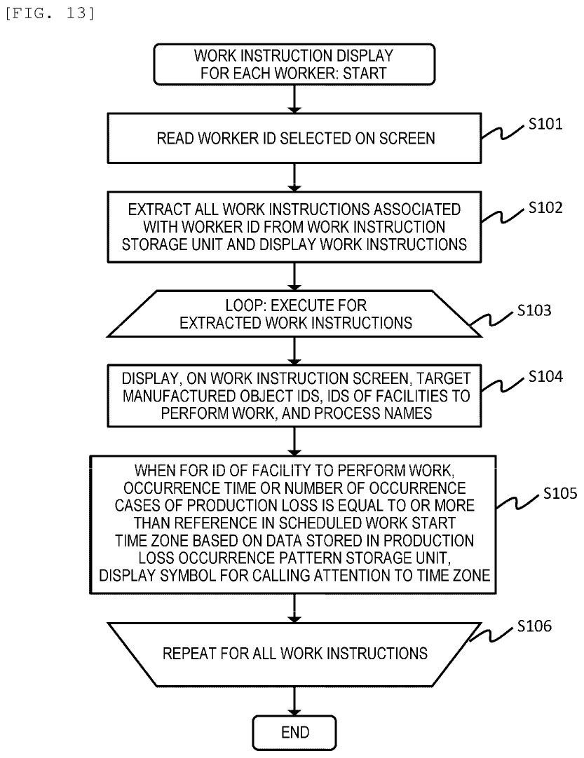

FIG. 13 is a diagram showing an example of a flow of work instruction display processing for each worker. The work instruction display processing for each worker is started at a predetermined time (for example, every day) or when an instruction to start the processing is issued to the work instruction device 200.

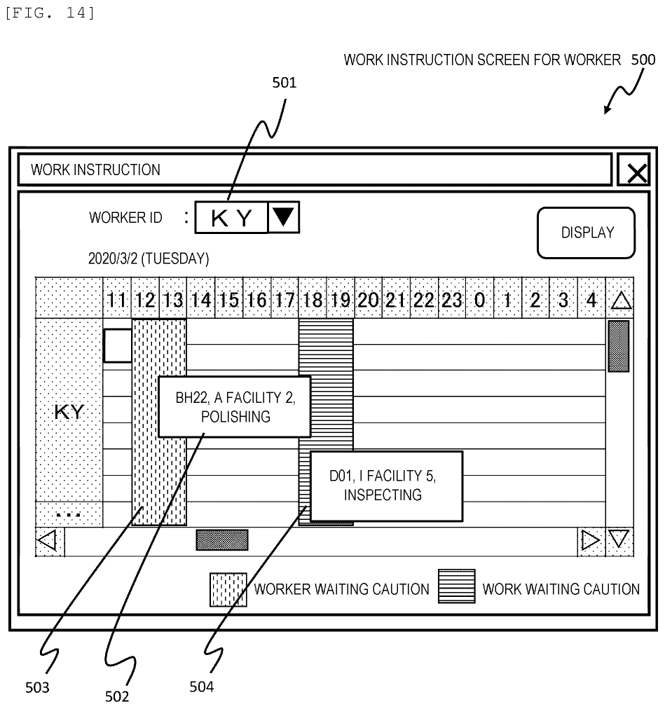

First, the work instruction generation unit 226 reads a worker ID selected on the screen (step S101). Specifically, the work instruction generation unit 226 generates a work instruction screen for worker 500 shown in FIG. 14, and receives the worker ID input to the worker input region 501.

Then, the work instruction generation unit 226 extracts all work instructions associated with the worker ID from the work instruction storage unit 216 and displays the work instructions (step S102).

Then, the work instruction generation unit 226 executes step S104 and step S105 for the extracted work instructions (steps S103 and S106).

The work instruction generation unit 226 displays, in the work instruction screen for worker 500, target manufactured object IDs and IDs of facilities to perform the work, and displays the process names (step S104). Specifically, regarding the work instructions extracted in step S102, the work instruction generation unit 226 displays information stored in the manufactured object ID column 216a, the facility ID column 216h, and the process name column 216d along the time axis as a work instruction 502 on the work instruction screen for worker 500.

Then, when for the ID of the facility to perform the work, the occurrence time or the number of occurrence cases of the production loss is equal to or more than values stored in the reference time column 215g and the reference number of cases column 215h in a scheduled work start time zone based on data stored in the production loss occurrence pattern storage unit 215, the work instruction generation unit 226 displays a symbol for calling attention to the time zone, for example, a worker waiting caution symbol 503 and a work waiting caution symbol 504 (step S105).

The above is an example of the flow of the work instruction display processing for each worker. According to the work instruction display processing for each worker, it is possible to display a risk of the production loss that the worker needs to pay attention to on the work instruction screen for worker, to perform a preparation for preventing the production loss in advance, and to improve a key performance indicator (KPI) such as production efficiency.

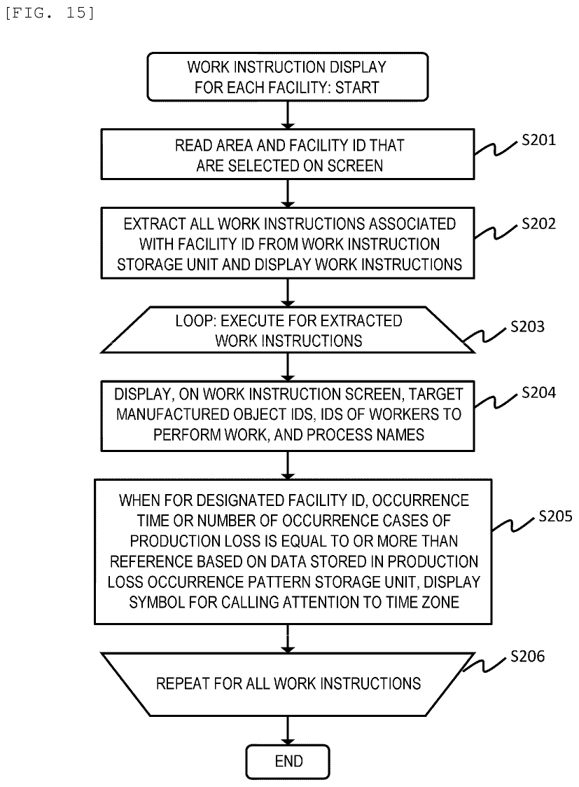

FIG. 15 is a diagram showing an example of a flow of work instruction display processing for each facility. The work instruction display processing for each facility is started at a predetermined time (for example, every day) or when an instruction to start the processing is issued to the work instruction device 200.

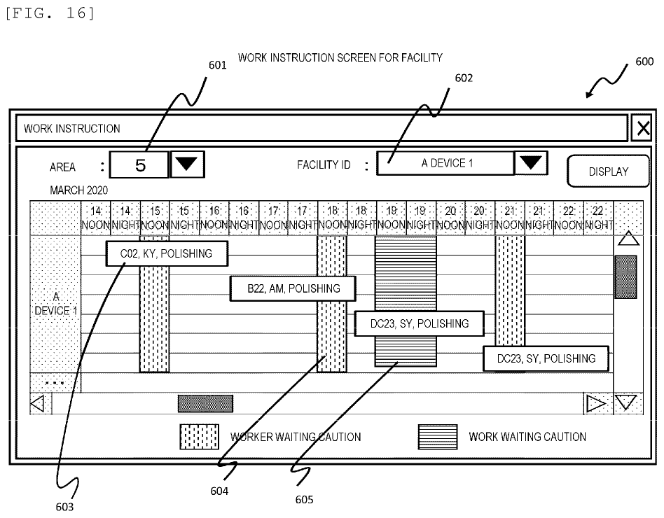

First, the work instruction generation unit 226 reads an area and a facility ID that are selected on the screen (step S201). Specifically, the work instruction generation unit 226 generates a work instruction screen for facility 600 shown in FIG. 16, and receives an area and a facility ID input to an area input region 601 and a facility ID input region 602 of the work instruction screen for facility 600, respectively.

Then, the work instruction generation unit 226 extracts all work instructions associated with the facility ID from the work instruction storage unit 216 and displays the work instructions (step S202).

Then, the work instruction generation unit 226 executes steps S204 and S205 for the extracted work instructions (steps S203 and S206).

The work instruction generation unit 226 displays, on the work instruction screen for facility 600, the target manufactured object IDs, IDs of the workers to perform the work, and the process names (step S204). Specifically, regarding the work instructions extracted in step S202, the work instruction generation unit 226 displays information stored in the manufactured object ID column 216a, the worker ID column 216i, and the process name column 216d along the time axis as a work instruction 603 on the work instruction screen for facility 600.

Then, when for a designated facility ID, the occurrence time or the number of occurrence cases of the production loss is equal to or more than the values stored in the reference time column 215g and the reference number of cases column 215h based on the data stored in the production loss occurrence pattern storage unit 215, the work instruction generation unit 226 displays the symbol for calling attention to the time zone, for example, a worker waiting caution symbol 604 and a work waiting caution symbol 605 (step S205).

The above is an example of the flow of the work instruction display processing for each facility. According to the work instruction display processing for each facility, it is possible to display the risk of the production loss that the worker needs to pay attention to on the work instruction screen for facility, to perform the preparation for preventing the production loss in advance, and to improve the key performance indicator (KPI) such as production efficiency.

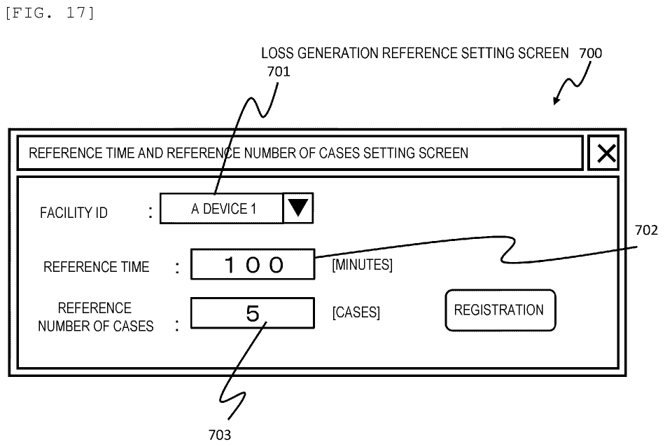

FIG. 17 is a diagram showing an example of a loss occurrence reference setting screen. The loss occurrence reference setting screen 700 receives inputs of a facility ID input column 701, a reference time input column 702, and a reference number of cases input column 703. The facility ID input column 701 receives an input of the facility ID. When an input of “ALL” is exceptionally received, the facility ID input column 701 uniformly receives IDs of all the facilities. The reference time input column 702 receives a reference time as a reference for determining an occurrence of the production loss in steps S105 and S205 of the work instruction display processing. The reference number of cases input column 703 receives the number of occurrence cases as the reference for determining an occurrence of the production loss in steps S105 and S205 of the work instruction display processing. Then, for the reference time and the reference number of cases of each facility that are received, the reference time column 215g and the reference number of cases column 215h of the production loss occurrence pattern storage unit 215 are updated.

The above is a configuration example of the work instruction system according to the first embodiment of the invention. According to the first embodiment, the production loss can be reduced using the shop-floor data.

The embodiment mentioned above has been described in detail for clearly explaining the invention, but is not necessarily limited to the inclusion of all the configurations described. It is possible to replace a part of a configuration according to an embodiment with another configuration, and it is also possible to add a configuration according to an embodiment to a configuration according to another embodiment. It is also possible to remove a part of a configuration according to an embodiment.

The above-mentioned parts, configurations, functions, processing units, and the like may be partially or entirely achieved with hardware, for example, by being designed with integrated circuits. The above-mentioned parts, configurations, functions, and the like may be achieved with software by a processor interpreting and executing programs for achieving the functions. Information such as programs, tables, and files for achieving the functions can be stored in recording devices such as memories and hard disks, or recording media such as IC cards, SD cards, and DVDs.

It is to be noted that control lines and information lines according to the above-mentioned embodiment that are considered required for the sake of explanation are shown, and not all control lines and information lines on a product are shown. In fact, it is conceivable that almost all the configurations are interconnected. The invention has been described with a focus on the embodiment.

### REFERENCE SIGN LIST

10 work instruction system
100 manufacturing shop-floor (area)
110 performance input terminal
120 work instruction terminal
130 controller
131 production device
200 work instruction device
210 storage unit
211 production performance storage unit
212 worker dynamics storage unit
213 facility operation history storage unit
214 work procedure storage unit
216 work instruction storage unit
220 processing unit
221 production performance collection unit
222 worker dynamics acquisition unit
223 facility operation history acquisition unit
224 4M data management unit
225 production loss occurrence pattern extraction unit
226 work instruction generation unit
230 communication unit
240 input unit
250 output unit

1. A work instruction device comprising:
a storage unit configured to store shop-floor data including production performance information for each manufactured object manufactured at a manufacturing shop-floor worker dynamics information obtained from a sensor attached to a worker at the manufacturing shop-floor, and information on an operation history of a facility at the manufacturing shop-floor;
a production loss occurrence pattern extraction unit configured to analyze the shop-floor data based on a predetermined method to generate a production loss occurrence pattern; and
a work instruction generation unit configured to estimate occurrence of a production loss based on a work plan for a work corresponding to a date and time, a facility, and a worker corresponding to the production loss occurrence pattern to generate work instruction information including information on a cause of the production loss.

2. The work instruction device according to claim 1, wherein
the production loss occurrence pattern extraction unit extracts a time zone during which the facility does not operate for each day of a week in an operation history of the facility, and determines that the production loss occurs when a time and the number of cases that are references are exceeded.

3. The work instruction device according to claim 1, wherein
the production loss occurrence pattern extraction unit extracts a non-operation time zone that is not included in a work model for each day of a week in an operation history of the facility, and determines that the facility is the cause of the production loss when the facility is stopped less than a scheduled operation time included in the work model.

4. The work instruction device according to claim 1, wherein
the production loss occurrence pattern extraction unit extracts a non-operation time zone that is not included in a work model for each day of a week in an operation history of the facility, and determines that the worker is the cause of the production loss when the facility operates beyond a scheduled operation time included in the work model and the facility is stopped.

5. The work instruction device according to claim 1, wherein
the work instruction generation unit displays, for each of works for each worker, a symbol for calling attention to the work instruction information when a facility used for the work, a start time point of the work, and the worker correspond to the production loss occurrence pattern, and an occurrence time or the number of occurrence cases of the production loss occurrence pattern is equal to or more than a predetermined reference.

6. The work instruction device according to claim 1, wherein
the work instruction generation unit displays, for each of works for each facility, a symbol for calling attention to the work instruction information when the facility used for the work, the manufactured object of the work, and the start time point of the work correspond to the production loss occurrence pattern, and an occurrence time or the number of occurrence cases of the production loss occurrence pattern is equal to or more than a predetermined reference.

7. A work instruction system comprising a work instruction device, a production device, a performance input terminal, and a sensor configured to acquire worker dynamics, wherein
the production device transmits, to the work instruction device, a history of an operation state of the own device for each time point,
the performance input terminal transmits, to the work instruction device, production performance information for specifying performances of start and end time points of a manufacturing process for each manufactured object,
the sensor transmits the acquired worker dynamics information to the work instruction device, and
the work instruction device comprises:
a communication unit configured to communicate with each of the production device, the performance input terminal, and the sensor;
a facility operation history acquisition unit configured to collect the history of an operation state via the communication unit;
a production performance collection unit configured to collect the production performance information via the communication unit;
a worker dynamics acquisition unit configured to collect the worker dynamics information via the communication unit;
a production loss occurrence pattern extraction unit configured to analyze the history of an operation state, the production performance information, and the worker dynamics information based on a predetermined method to generate a production loss occurrence pattern; and
a work instruction generation unit configured to estimate occurrence of a production loss based on a work plan for a work corresponding to a date and time, a facility, and a worker corresponding to the production loss occurrence pattern to generate work instruction information including information on a cause of the production loss.

8. A work instruction method using a work instruction device, wherein
the work instruction device comprises: a processor; and a storage unit configured to store shop-floor data including production performance information for each manufactured object manufactured at a manufacturing shop-floor, worker dynamics information obtained from a sensor attached to a worker at the manufacturing shop-floor, and information on an operation history of a facility at the manufacturing shop-floor, and
the processor performs:
a production loss occurrence pattern extraction step of analyzing the shop-floor data based on a predetermined method to generate a production loss occurrence pattern; and
a work instruction generation step of estimating occurrence of a production loss based on a work plan for a work corresponding to a date and time, a facility, and a worker corresponding to the production loss occurrence pattern to generate work instruction information including information on a cause of the production loss.
